(19) United States
(12) Patent Application Publication
(10) Pub. No.: US 2026/0213627 A1
(43) Pub. Date: Jul. 23, 2026

(54) INTERFACE CONTROL BOARD FOR ELECTRIC GENERATOR AND OPERATING METHOD THEREOF

(71) Applicants: CHONGQING DINKING POWER MACHINERY CO., LTD., CHONGQING (CN); CHONGQING BAIBANG MICRO TECHNOLOGY CO., LTD., CHONGQING (CN)

(72) Inventors: XIANG LIU, CHONGQING (CN); JINBO LU, CHONGQING (CN); DAWEI JIANG, CHONGQING (CN); SHIQIAN XIE, CHONGQING (CN); HAI XU, CHONGQING (CN)

(21) Appl. No.: 19/068,463

(22) Filed: Mar. 3, 2025

(30) Foreign Application Priority Data
Jan. 23, 2025 (CN) 202510110053.7

(51) Int. Cl. H02K 11/33; H02K 11/00; H02K 11/40

(52) U.S. Cl. CPC H02K 11/33; H02K 11/0094; H02K 11/40; H02K 2211/03

(57) ABSTRACT

The invention provides an interface control board for an electric generator and an operating method thereof. The interface control board comprises a circuit board, wherein M interfaces are arranged on a front side of the circuit board, N interfaces are arranged on a back side of the circuit board, M and N are positive integers, and M>N. The interface control board further comprises interface circuits arranged on the circuit board, and the M interfaces are converted into the N interfaces by means of the interface circuits. The interface control board is added, and all necessary functional elements are connected by means of the interface control board with only a few wires, such that the control board can be installed and replaced more easily and quickly.

### BACKGROUND OF THE INVENTION

### 1. Technical Field

The invention relates to the technical field of electric generators, in particular to an interface control board for an electric generator and an operating method thereof.

### 2. Description of Related Art

Electric generators are equipment used for converting mechanical energy into electric energy. A control board on a traditional electric generator is directly connected to parts of functional modules by means of wires, thus being difficult to replace and install.

### BRIEF SUMMARY OF THE INVENTION

To solve at least the technical problems in the prior art, the invention particularly and creatively proposes an interface control board for an electric generator and an operating method thereof.

To fulfill the above purpose of the invention, the invention provides an interface control board for an electric generator, comprising a circuit board, wherein M interfaces are arranged on a front side of the circuit board, N interfaces are arranged on a back side of the circuit board, M and N are positive integers, and M>N;
the interface control board for an electric generator further comprises interface circuits arranged on the circuit board, and the M interfaces are converted into the N interfaces by means of the interface circuits.

In a preferred embodiment of the invention, the M interfaces comprise one or any combination of an AC line interface J20, an AC line interface J23, an AC ground wire interface J16, a master damper interface J11, a charging interface J7, a master reset and idle interface J8, a voltage stabilizer 0802 and USB interface J3, a thermal protection and cigarette lighter interface J2, a CO display panel interface J15, a display instrument interface J26, a power switch interface J4, a slave damper interface J12, a slave reset and idle interface J10, a master/slave operation selection interface J19, a control module 8-core interface J24, a one-touch start interface J25, a control module 12-core interface J17, an ATS interface J1, a control module 4-core interface J18 and an LED three-in-one display panel interface J28.

In a preferred embodiment of the invention, the N interfaces comprise one or any combination of a DC interface J5, a DC interface J6, an AC interface J21, an AC interface J22, an AC ground wire interface J13, an AC ground wire interface J14, a CO interface J9, a master 16-core interface J27, a master 12-core interface J30, a slave 16-core interface J29 and a slave 12-core interface J31.

In a preferred embodiment of the invention, the interface circuits comprise one or any combination of a first power interface circuit, a second power interface circuit, a thermal protection and cigarette lighter interface circuit, an ATS interface circuit, a power switch interface circuit, a charging interface circuit, a master reset and idle interface circuit, a slave reset and idle interface circuit, an AC ground wire interface circuit, a master 16-core interface circuit, a master 12-core interface circuit, a slave 16-core interface circuit, a slave 12-core interface circuit, a display instrument interface circuit, a CO interface circuit, a control module 8-core interface circuit, a control module 12-core interface circuit, a master 12-core interface circuit, a control module 4-core interface module and an AC interface circuit.

In conclusion, by adopting the above technical solution, the interface control board is added, and all necessary functional elements are connected by means of the interface control board with only a few wires, such that the control board can be installed and replaced more easily and quickly.

### BRIEF DESCRIPTION OF THE SEVERAL VIEWS OF THE DRAWINGS

FIG. 1 is a schematic diagram of N interfaces on a back side of a circuit board according to the invention.

FIG. 2 is a schematic diagram of M interfaces on a front side of the circuit board according to the invention.

FIGS. 3-12 are schematic diagrams of interface circuits according to the invention.

### DETAILED DESCRIPTION OF THE INVENTION

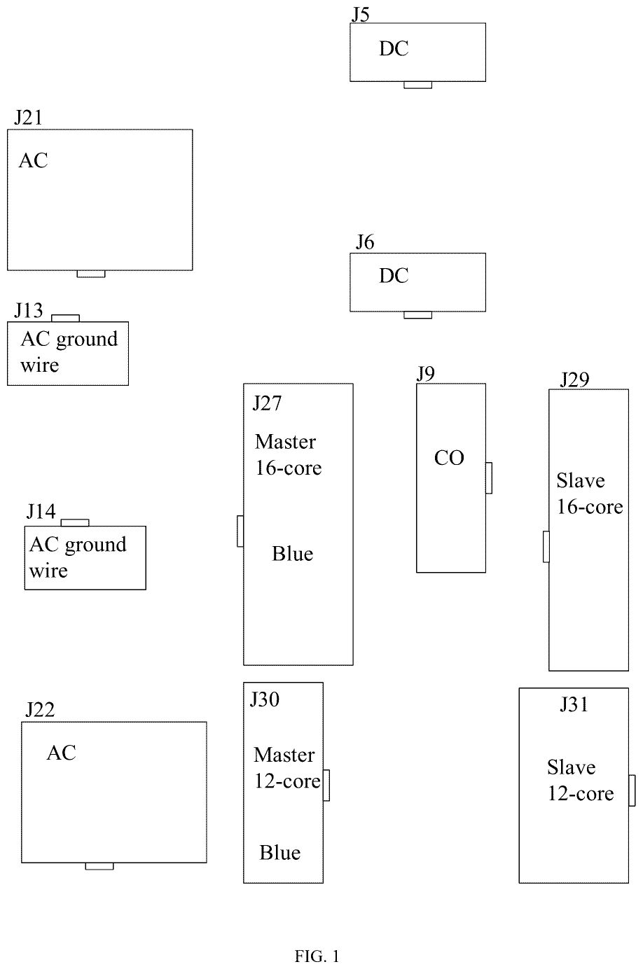

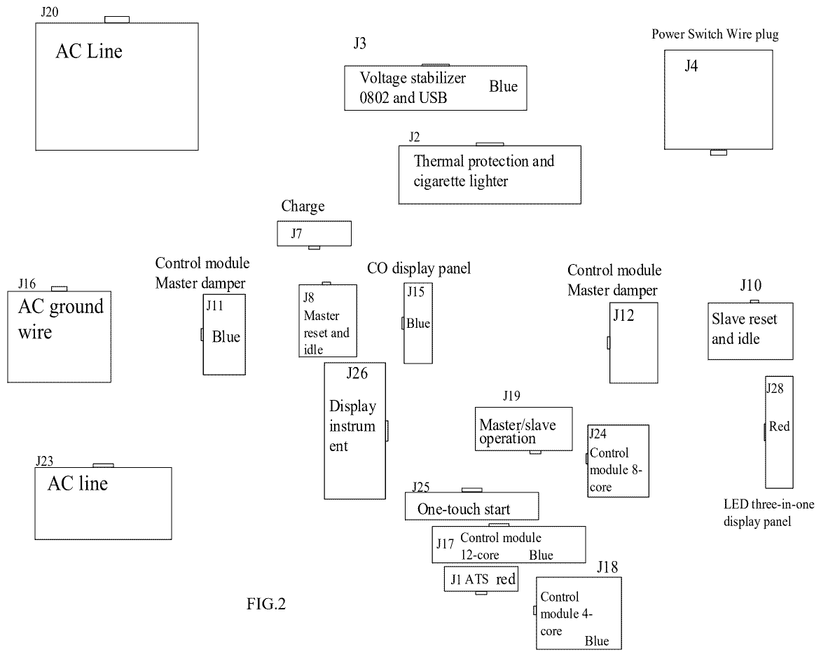

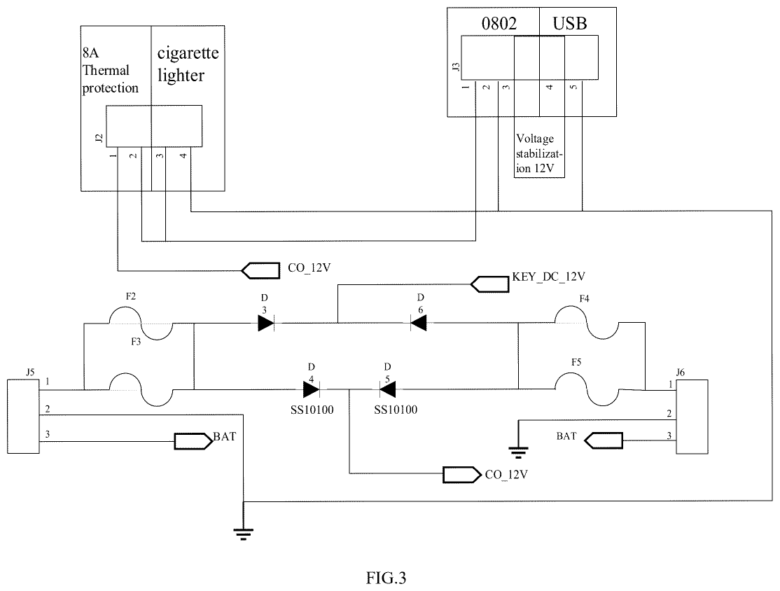

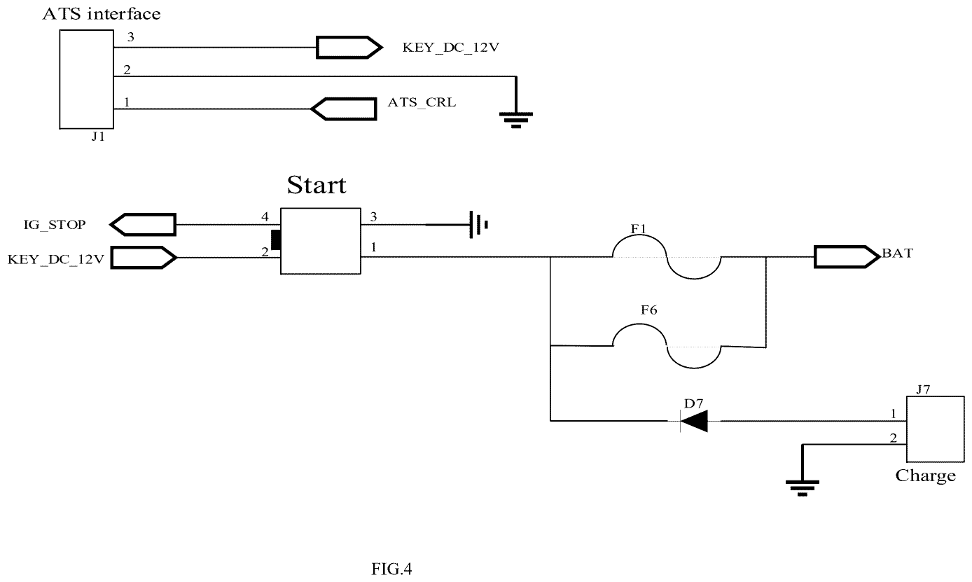

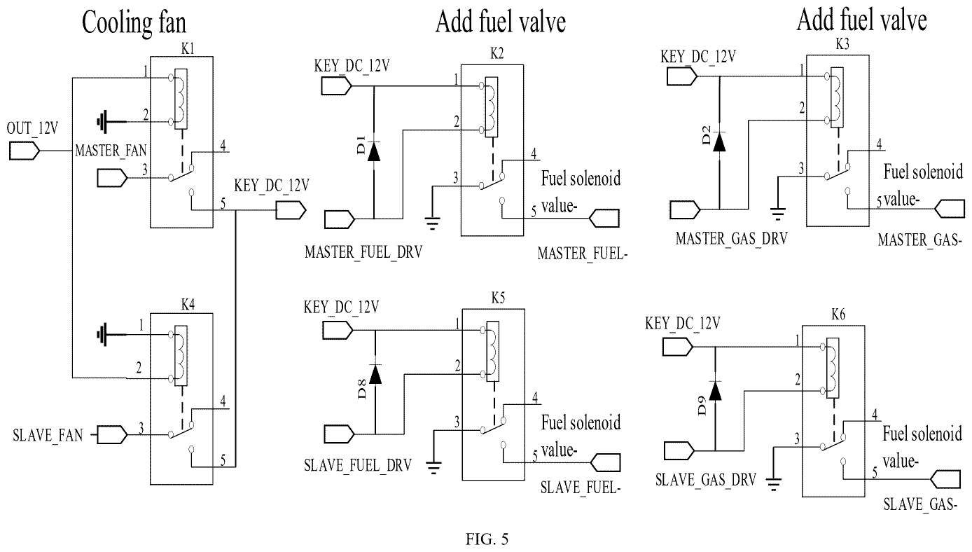

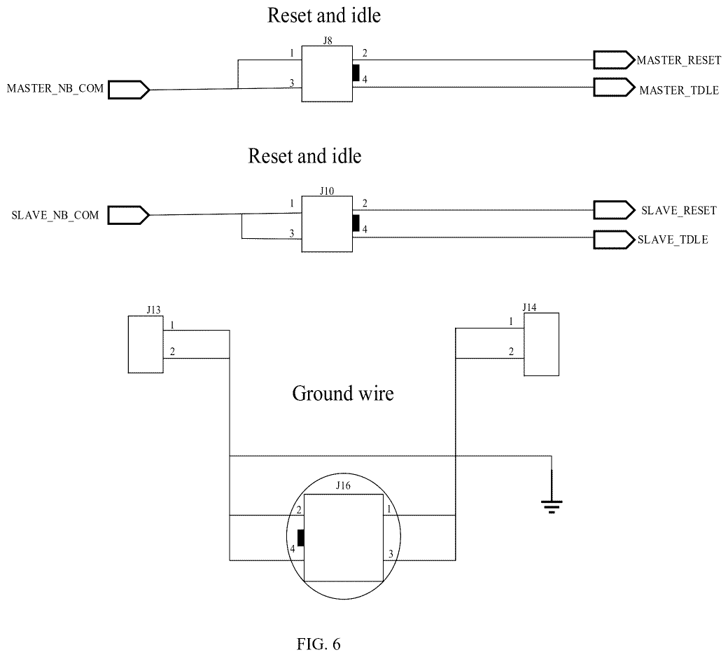

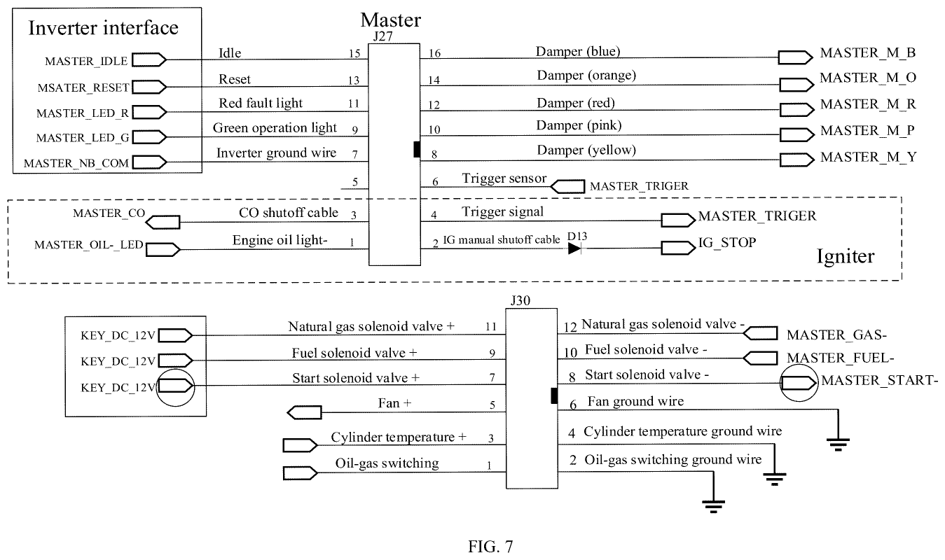

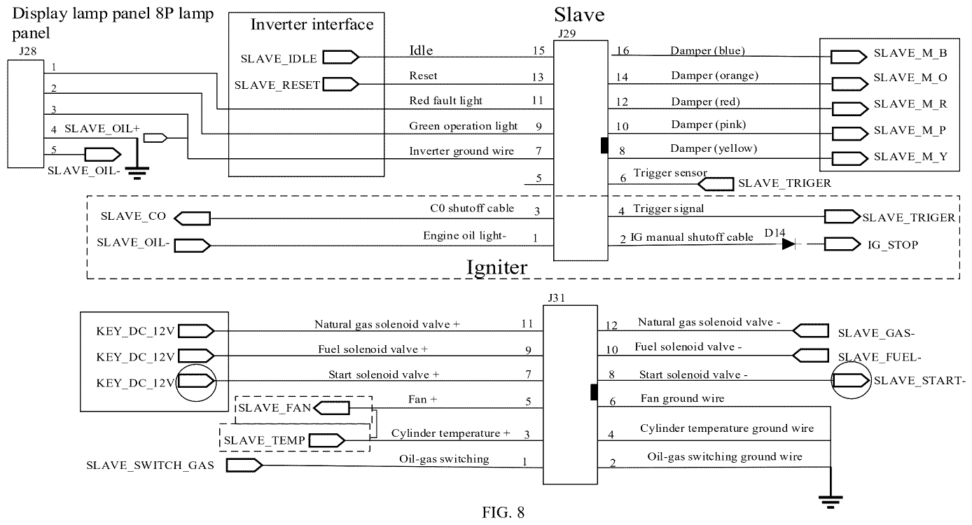

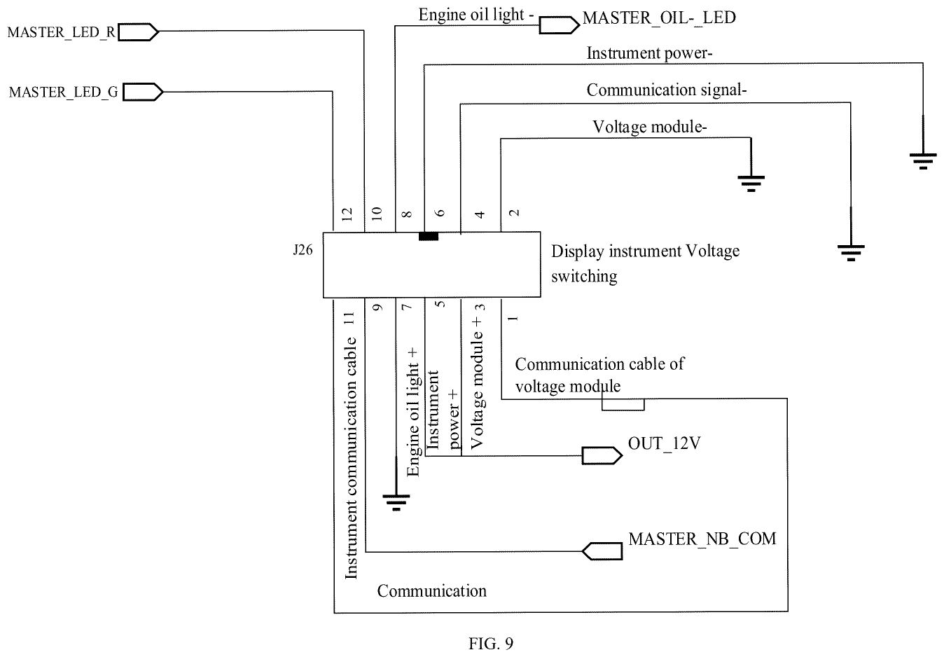

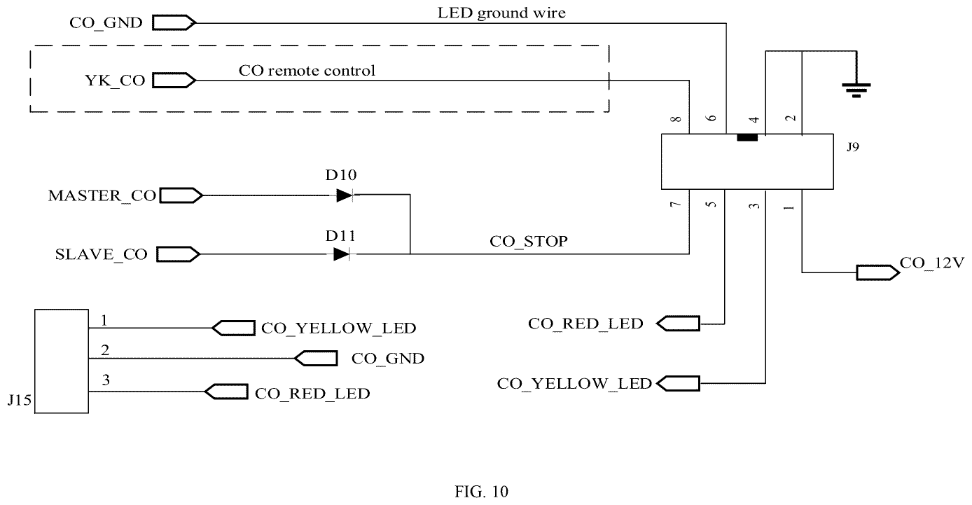

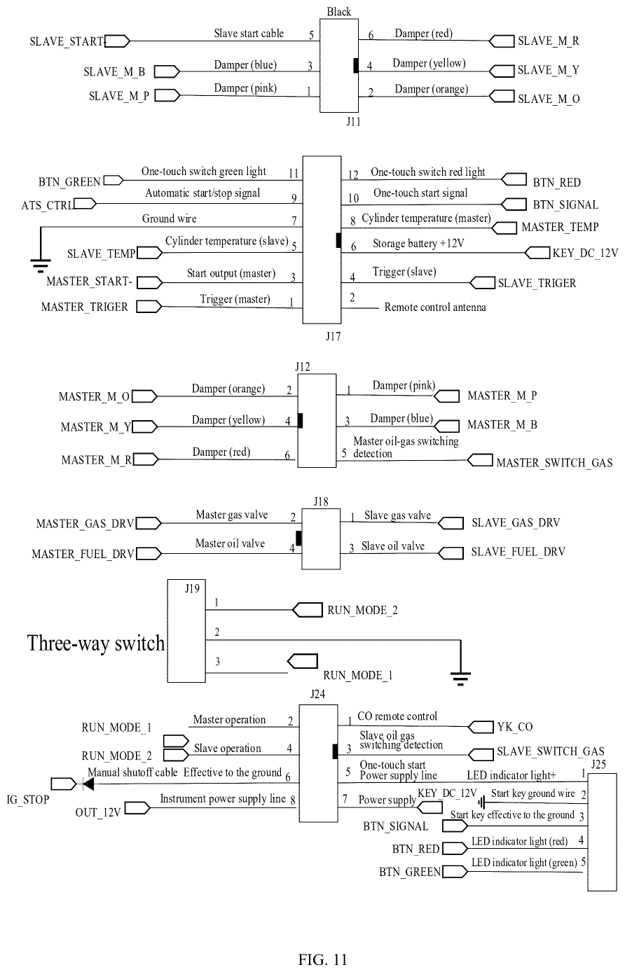

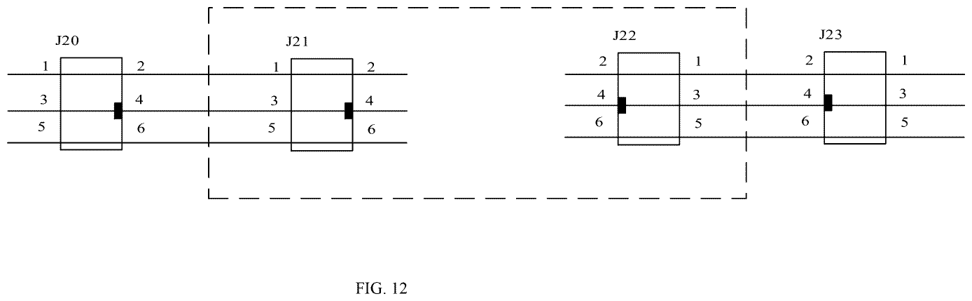

An interface control board for an electric generator comprises a circuit board, wherein as shown in FIGS. 1-12, M interfaces are arranged on a front side of the circuit board, and N interfaces are arranged on a back side of the circuit board, M and N are positive integers, and M>N;
the interface control board for an electric generator further comprises interface circuits arranged on the circuit board, and the M interfaces are converted into the N interfaces by means of the interface circuits.

In a preferred embodiment of the invention, the M interfaces comprise one or any combination of an AC line interface J20, an AC line interface J23, an AC ground wire interface J16, a master damper interface J11, the charging interface J7, a master reset and idle interface J8, a voltage stabilizer 0802 and USB interface J3, a thermal protection and cigarette lighter interface J2, a CO display panel interface J15, a display instrument interface J26, a power switch interface J4, a slave damper interface J12, a slave reset and idle interface J10, a master/slave operation selection interface J19, a control module 8-core interface J24, a one-touch start interface J25, a control module 12-core interface J17, an ATS interface J1, a control module 4-core interface J18 and an LED three-in-one display panel interface J28.

In a preferred embodiment of the invention, the N interfaces comprise one or any combination of a DC interface J5, a DC interface J6, an AC interface J21, an AC interface J22, an AC ground wire interface J13, an AC ground wire interface J14, a CO interface J9, a master 16-core interface J27, a master 12-core interface J30, a slave 16-core interface J29 and a slave 12-core interface J31.

In a preferred embodiment of the invention, the interface circuits comprise one or any combination of a first power interface circuit, a second power interface circuit, a thermal protection and cigarette lighter interface circuit, an ATS interface circuit, a power switch interface circuit, a charging interface circuit, a master reset and idle interface circuit, a slave reset and idle interface circuit, an AC ground wire interface circuit, a master 16-core interface circuit, a master 12-core interface circuit, a slave 16-core interface circuit, a slave 12-core interface circuit, a display instrument interface circuit, a CO interface circuit, a control module 8-core interface circuit, a control module 12-core interface circuit, a master 12-core interface circuit, a control module 4-core interface module and an AC interface circuit.

In a preferred embodiment of the invention, the first power interface circuit is configured as follows: a first pin of the DC interface J5 is connected to a first terminal of a fuse F2, a second terminal of the fuse F2 is connected to a positive pole of a diode D3, and a negative pole of the diode D3 outputs a power supply KEY_DC_12V; a second pin of the DC interface J5 is connected to a power ground; a third pin of the DC interface J5 outputs a power supply BAT;
the first power interface circuit is further configured as follows: the first pin of the DC interface J5 is connected to a first terminal of a fuse F3, a second terminal of the fuse F3 is connected to a positive pole of a diode D4, and a negative pole of the diode D4 outputs a power supply CO_12V;
the first power interface circuit is further configured as follows: the second terminal of the fuse F2 is connected to the second terminal of the fuse F3, such that the power supply KEY_DC_12V and the power supply CO_12V will still be output even if the fuse F2 and the fuse F3 are not fused at the same time;
the second power interface circuit is configured as follows: a first pin of the DC interface J6 is connected to a first terminal of a fuse F4, a second terminal of the fuse F4 is connected to a positive pole of a diode D6, and a negative pole of the diode D6 outputs the power supply KEY_DC_12V; a second pin of the DC interface J6 is connected to the power ground; a third pin of the DC interface J6 outputs the power supply BAT;
the second power interface circuit is further configured as follows: the positive pole of the diode D6 is connected to the negative pole of the diode D3, such that the power KEY_DC_12V is output by the first pin of the DC interface J5 or/and the first pin of the DC interface J6;
the second power interface circuit is further configured as follows: the first pin of the DC interface J6 is connected to a first terminal of a fuse F5, a second terminal of the fuse F5 is connected to a positive pole of a diode D5, and a negative pole of the diode D5 outputs the power supply CO_12V;
the second power interface circuit is further configured as follows: the negative pole of the diode D5 is connected to the negative pole of the diode D4, such that the power supply CO_12V is output by the first pin of the DC interface J5 or/and the first pin of the DC interface J6;
the second power interface is further configured as follows: the second terminal of the fuse F4 is connected to the second terminal of the fuse F5, such that the power supply KEY_DC_12V and the power supply CO_12V will still be output even if the fuse F4 and the fuse F5 are not fused at the same time;
the thermal protection and cigarette lighter interface circuit is configured as follows: a first pin of the thermal protection and cigarette lighter interface J2 is connected to the power supply CO_12V, a second pin of the thermal protection and cigarette lighter interface J2 and a third pin of the thermal protection and cigarette lighter interface J2 are connected to a first pin of the voltage stabilizer 0802 and USB interface J3, and a fourth pin of the thermal protection and cigarette lighter interface J2 is connected to the power ground;
the voltage stabilizer 0802 and USB interface circuit is configured as follows: the first pin of the voltage stabilizer 0802 and USB interface J3 is connected to the second pin of the thermal protection and cigarette lighter interface J2 and the third pin of the thermal protection and cigarette lighter interface J2, a second pin of the voltage stabilizer 0802 and USB interface J3 is connected to the power ground, a third pin of the voltage stabilizer 0802 and USB interface J3 is connected to a fourth pin of the voltage stabilizer 0802 and USB interface J3, and a fifth pin of the voltage stabilizer 0802 and USB interface J3 is connected to the power ground;
the ATS interface circuit is configured as follows: a first pin of the ATS interface J1 is connected to a ninth pin of the control module 12-core interface J17, a second pin of the ATS interface J1 is connected to the power ground, and a third pin of the ATS interface J1 is connected to the power supply KEY_DC_12V;
the AC interface circuit is configured as follows: a first pin of the AC line interface J20 and a second pin of the AC line interface J20 are respectively connected to a first pin of the AC interface J21 and a second pin of the AC interface J21; a third pin of the AC line interface J20 and a fourth pin of the AC line interface J20 are respectively connected to a third pin of the AC interface J21 and a fourth pin of the AC interface J21; a fifth pin of the AC line interface J20 and a sixth pin of the AC line interface J20 are respectively connected to a fifth pin of the AC interface J21 and a sixth pin of the AC interface J21;
a first pin of the AC interface J22 and a second pin of the AC interface J22 are respectively connected to a first pin of the AC line interface J23 and a second pin of the AC line interface J23, a third pin of the AC interface J22 and a fourth pin of the AC interface J22 are respectively connected to a third pin of the AC line interface J23 and a fourth pin of the AC line interface J23, and a fifth pin of the AC interface J22 and a sixth pin of the AC interface J22 are respectively connected to a fifth pin of the AC line interface J23 and a sixth pin of the AC line interface J23;
the power switch interface circuit is configured as follows: a first pin of the power switch interface J4 is connected to a first terminal of a fuse F1, and a second terminal of the fuse F1 is connected to the power supply BAT; a second pin of the power switch interface J4 is connected to the power supply KEY_DC_12V, a third pin of the power switch interface J4 is connected to the power ground, a fourth pin of the power switch interface J4 is connected to a negative pole of a diode D13, and a positive pole of the diode D13 is connected to a second pin of the master 16-core interface J27;
the charging interface circuit is configured as follows: a first pin of the charging interface J7 is connected to a positive pole of a diode D7, a negative pole of the diode D7 is connected to a first terminal of a fuse F6, and a second terminal of the fuse F6 is connected to the first terminal of the fuse F1; a second pin of the charging interface J7 is connected to the power ground;
the charging interface circuit is further configured as follows: the first terminal of the fuse F6 is connected to the first terminal of the fuse F1;
the master reset and idle interface circuit is configured as follows: a first pin of the master reset and idle interface J8 and a third pin of the master reset and idle interface J8 are respectively connected to a seventh pin of the master 16-core interface J27 and a ninth pin of the display instrument interface J26, a second pin of the master reset and idle interface J8 is connected to a thirteenth pin of the master 16-core interface J27, and a fourth pin of the master reset and idle interface J8 is connected to a fifteenth pin of the master 16-core interface J27;
the slave reset and idle interface circuit is configured as follows: a first pin of the slave reset and idle interface J10 and a third pin of the slave reset and idle interface J10 are respectively connected to a seventh pin of the slave 16-core interface J29 and a third pin of the LED three-in-one display panel interface J28, a second pin of the slave reset and idle interface J10 is connected to a thirteenth pin of the slave 16-core interface J29, and a fourth pin of the slave reset and idle interface J10 is connected to a fifteenth pin of the slave 16-core interface J29;
the AC ground wire interface circuit is configured as follows: a first pin of the AC ground wire interface J13 and a second pin of the AC ground wire interface J13 are respectively connected to the power ground and a second pin and a fourth pin of the AC ground wire interface J16;
the AC ground wire interface circuit is further configured as follows: a first pin of the AC ground wire interface J14 and a second pin of the AC ground wire interface J14 are respectively connected to the power ground and a first pin and a third pin of the AC ground wire interface J16;
the master 16-core interface circuit is configured as follows: a first pin of the master 16-core interface J27 is connected to an eighth pin of the display instrument interface J26; a third pin of the master 16-core interface J27 is connected to a positive pole of a diode D10, and a negative pole of the diode D10 is connected to a seventh pin of the CO interface J9; a fourth pin of the master 16-core interface J27 is connected to a sixth pin of the master 16-core interface J27; an eighth pin of the master 16-core interface J27 is connected to a fourth pin of the slave damper interface J12; a tenth pin of the master 16-core interface J27 is connected to a first pin of the slave damper interface J12; a twelfth pin of the master 16-core interface J27 is connected to a sixth pin of the slave damper interface J12; a fourteenth pin of the master 16-core interface J27 is connected to a second pin of the slave damper interface J12; a sixteenth pin of the master 16-core interface J27 is connected to a third pin of the slave damper interface J12; a ninth pin of the master 16-core interface J27 is connected to a twelfth pin of the display instrument interface J26; an eleventh pin of the master 16-core interface J27 is connected to a tenth pin of the display instrument interface J26;
the master 12-core interface circuit is configured as follows: a first pin of the master 12-core interface J30 is connected to a fifth pin of the slave damper interface J12; a second pin of the master 12-core interface J30 is connected to the power ground; a third pin of the master 12-core interface J30 is connected to an eighth pin of the control module 12-core interface J17; a fourth pin of the master 12-core interface J30 is connected to the power ground; a fifth pin of the master 12-core interface J30 is connected to the fifth pin of the slave damper interface J12; a sixth pin of the master 12-core interface J30 is connected to the power ground; an eighth pin of the master 12-core interface J30 is connected to a third pin of the control module 12-core interface J17; a seventh pin of the master 12-core interface J30 is connected to the power supply KEY_DC_12V; a ninth pin of the master 12-core interface J30 is connected to the power supply KEY_DC_12V; an eleventh pin of the master 12-core interface J30 is connected to the power supply KEY_DC_12V;
the slave 16-core interface circuit is configured as follows: a first pin of the slave 16-core interface J29 is connected to a fifth pin of the LED three-in-one display panel interface J28; a second pin of the slave 16-core interface J29 is connected to a positive pole of a diode D14, and a negative pole of the diode D14 is connected to a fourth pin of the power switch interface J4; a third pin of the slave 16-core interface J29 is connected to a positive pole of a diode D11, and a negative pole of the diode D11 is connected to the seventh pin of the CO interface J9; a fourth pin of the slave 16-core interface J29 is connected to a sixth pin of the slave 16-core interface J29; an eighth pin of the slave 16-core interface J29 is connected to a fourth pin of the master damper interface J11; a tenth pin of the slave 16-core interface J29 is connected to a first pin of the master damper interface J11; a twelfth pin of the slave 16-core interface J29 is connected to a sixth pin of the master damper interface J11; a fourteenth pin of the slave 16-core interface J29 is connected to a second pin of the master damper interface J11; a sixteenth pin of the slave 16-core interface J29 is connected to a third pin of the master damper interface J11; a ninth pin of the slave 16-core interface J29 is connected to a second pin of the LED three-in-one display panel interface J28; an eleventh pin of the slave 16-core interface J29 is connected to a first pin of the LED three-in-one display panel interface J28; a fourth pin of the LED three-in-one display panel interface J28 is connected to the power ground;
the slave 12-core interface circuit is configured as follows: a second pin of the slave 12-core interface J31, a fourth pin of the slave 12-core interface J31 and a sixth pin of the slave 12-core interface J31 are connected to the power ground; an eighth pin of the slave 12-core interface J31 is connected to a fifth pin of the master damper interface J11; a first pin of the slave 12-core interface J31 is connected to a third pin of the control module 8-core interface J24; a third pin of the slave 12-core interface J31 is connected to a fifth pin of the control module 12-core interface J17; a seventh pin of the slave 12-core interface J31, a ninth pin of the slave 12-core interface J31 and an eleventh pin of the slave 12-core interface J31 are connected to the power supply KEY_DC_12V;
the display instrument interface circuit is configured as follows: a first pin of the display instrument interface J26 is connected to an eleventh pin of the display instrument interface J26; a second pin of the display instrument interface J26 and a fourth pin of the display instrument interface J26 are connected to the power ground; a third pin of the display instrument interface J26 and a fifth pin of the display instrument interface J26 are connected to the power supply OUT_12V; a seventh pin of the display instrument interface J26 is connected to the power ground; the tenth pin of the display instrument interface J26 is connected to the eleventh pin of the master 16-core interface J27; the twelfth pin of the display instrument interface J26 is connected to the ninth pin of the master 16-core interface J27;
the CO interface circuit is configured as follows: a first pin of the CO interface J9 is connected to the power supply CO_12V; a second pin of the CO interface J9 and a fourth pin of the CO interface J9 are connected to the power ground; a third pin of the CO interface J9 is connected to a first pin of the CO display panel interface J15; a fifth pin of the CO interface J9 is connected to a third pin of the CO display panel interface J15; a sixth pin of the CO interface J9 is connected to a second pin of the CO display panel interface J15; an eighth pin of the CO interface J9 is connected to a first pin of the control module 8-core interface J24;
the control module 8-core interface circuit is configured as follows: a fifth pin of the control module 8-core interface J24 is connected to a first pin of the one-touch start interface J25, a second pin of the one-touch start interface J25 is connected to the power ground, a third pin of the one-touch start interface J25 is connected to a tenth pin of the control module 12-core interface J17, a fourth pin of the one-touch start interface J25 is connected to a twelfth pin of the control module 12-core interface J17, a fifth pin of the one-touch start interface J25 is connected to an eleventh pin of the control module 12-core interface J17, a seventh pin of the control module 8-core interface J24 is connected to the power supply KEY_DC_12V, a second pin of the control module 8-core interface J24 is connected to a third pin of the master/slave operation selection interface J19, a fourth pin of the control module 8-core interface J24 is connected to a first pin of the master/slave operation selection interface J19, a second pin of the master/slave operation selection interface J19 is connected to the power ground, a sixth pin of the control module 8-core interface J24 is connected to a positive pole of a diode D12, and a negative pole of the diode D12 is connected to the negative pole of the diode D13; an eighth pin of the control module 8-core interface J24 outputs the power supply OUT_12V;
the control module 12-core interface circuit is configured as follows: a seventh pin of the control module 12-core interface J17 is connected to the power ground, a sixth pin of the control module 12-core interface J17 is connected to the power supply KEY_DC_12V, a fourth pin of the control module 12-core interface J17 is connected to the fourth pin of the slave 16-core interface J29, a first pin of the control module 12-core interface J17 is connected to the fourth pin of the master 16-core interface J27, and a second pin of the control module 12-core interface J17 is connected to an antenna;
the master 12-core interface circuit is configured as follows: a first terminal of an input circuit of a relay K1 is connected to the power supply OUT_12V, and a second terminal of the input circuit of the relay K1 is connected to the power ground; a first terminal of a normally open output circuit of the relay K1 is connected to the power supply KEY_DC_12V, and a second terminal of the normally open output circuit of the relay K1 is connected to the fifth pin of the master 12-core interface J30;
the master 12-core interface circuit is further configured as follows: a first terminal of an input circuit of a relay K4 is connected to the power supply OUT_12V, a second terminal of the input circuit of the relay K4 is connected to the power ground, a first terminal of a normally open output circuit of the relay K4 is connected to the power supply KEY_DC_12V, and a second terminal of the normally open output circuit of the relay K4 is connected to the fifth pin of the slave 12-core interface J31;
the control module 4-core interface circuit is configured as follows: a first terminal of an input circuit of a relay K2 is connected to a negative pole of a diode D1 and the power supply KEY_DC_12V, and a second terminal of the input circuit of the relay K2 is connected to a positive pole of the diode D1 and a fourth pin of the control module 4-core interface J18; a first terminal of a normally open output circuit of the relay K2 is connected to the power ground, and a second terminal of the normally open output circuit of the relay K2 is connected to a tenth pin of the master 12-core interface J30;
the control module 4-core interface circuit is further configured as follows: a first terminal of an input circuit of a relay K3 is connected to a negative pole of a diode D2 and the power supply KEY_DC_12V, and a second terminal of the input circuit of the relay K3 is connected to a positive pole of the diode D2 and a second pin of the control module 4-core interface J18; a first terminal of a normally open output circuit of the relay K3 is connected to the power ground, and a second terminal of the normally open output circuit of the relay K3 is connected to a twelfth pin of the master 12-core interface J30;
the control module 4-core interface circuit is further configured as follows: a first terminal of an input circuit of a relay K5 is connected to a negative pole of a diode D8 and the power supply KEY_DC_12V, and a second terminal of the input circuit of the relay K5 is connected to the positive pole of the diode D2 and a third pin of the control module 4-core interface J18; a first terminal of a normally open output circuit of the relay K5 is connected to the power ground, and a second terminal of the normally open output circuit of the relay K5 is connected to a tenth pin of the slave 12-core interface J31;
the control module 4-core interface circuit is further configured as follows: a first terminal of an input circuit of a relay K6 is connected to a negative pole of a diode D9 and the power supply KEY_DC_12V, and a second terminal of the input circuit of the relay K6 is connected to a positive pole of the diode D9 and a first pin of the control module 4-core interface J18; a first terminal of a normally open output circuit of the relay K6 is connected to the power ground, and a second terminal of the normally open output circuit of the relay K6 is connected to a twelfth pin of the slave 12-core interface J31.

Wherein, the model of the thermal protection and cigarette lighter interface J2 is HX63080_SINGLE_4P; the model of the voltage stabilizer 0802 and USB interface J3 and the one-touch start interface J25 is MX4.2_5569_SIP_5; the model of the diode D3, the diode D4, the diode D5, the diode D6 and the diode D7 is SMC_DO214AB or SS10100; the model of the power switch interface J4 is MX4.2_5569_4P; the model of the charging interface J7 is MX4.2_5569_SIP_2; the model of the relay K1, the relay K2, the relay K3, the relay K4, the relay K5 and the relay K6 is HFKC; the model of the AC ground wire interface J13 and the AC ground wire interface J14 is HX63080_SINGLE_2P, the model of the AC line interface J20, the AC line interface J23, the AC interface J21 and the AC interface J22 is HX63080_6P; the model of the CO interface J9 is MX4.2_5569_8P; the model of the master/slave operation selection interface J19 and the CO display panel interface J15 is MX4.2_5569_SIP_3. All elements other than the interfaces may be arranged on the front side of the circuit board, such that the circuit board can be closer to/better fit a protective shell, thus saving space; and the layout of the interfaces and the elements may be set according to the interface circuits and the actual condition.

In a preferred embodiment of the invention, the M interfaces comprise the AC line interface J20, the AC line interface J23, the AC ground wire interface J16, the master damper interface J11, the charging interface J7, the master reset and idle interface J8, the voltage stabilizer 0802 and USB interface J3, the thermal protection and cigarette lighter interface J2, the CO display panel interface J15, the display instrument interface J26, the power switch interface J4, the slave damper interface J12, the slave reset and idle interface J10, the master/slave operation selection interface J19, the control module 8-core interface J24, the one-touch start interface J25, the control module 12-core interface J17, the ATS (automatic transfer switch) interface J1, the control module 4-core interface J18 and the LED three-in-one display panel interface J28; in this case, M is 20;
the N interfaces comprise the DC interface J5, the DC interface J6, the AC interface J21, the AC interface J22, the AC ground wire interface J13, the AC ground wire interface J14, the CO (carbon monoxide) interface J9, the master 16-core interface J27, the master 12-core interface J30, the slave 16-core interface J29 and the slave 12-core interface J31; in this case, N is 11.

In a preferred embodiment of the invention, the interface circuits comprise the first power interface circuit, the second power interface circuit, the thermal protection and cigarette lighter interface circuit, the ATS interface circuit, the power switch interface circuit, the charging interface circuit, the master reset and idle interface circuit, the slave reset and idle interface circuit, the AC ground wire interface circuit, the master 16-core interface circuit, the master 12-core interface circuit, the slave 16-core interface circuit, the slave 12-core interface circuit, the display instrument interface circuit, the CO interface circuit, the control module 8-core interface circuit, the control module 12-core interface circuit, the master 12-core interface circuit, the control module 4-core interface module and the AC interface circuit.

In a preferred embodiment of the invention, the circuit board is an independent circuit board or formed by multiple independent circuit boards. In a case where the circuit board is formed by multiple independent circuit boards, the AC interface circuit, the AC line interface J20, the AC interface J21, the AC interface J22, the AC line interface J23, the AC ground wire interface J13, the AC ground wire interface J14, the AC ground wire interface J16 and the AC ground wire interface circuit may be arranged on one circuit board, and the other interfaces and interface circuits may be arranged on the other circuit board or remaining circuit boards.

The invention further discloses an operating method of an interface control board for an electric generator, comprising the following steps:
S1, preparing a protective shell, a length and width of which are greater than or equal to a length and width of a circuit board (an interface control board);
S2, forming N through-holes, matching N interfaces in size and position, in the protective shell to allow the N interfaces on a back side of the circuit board to stretch out of the protective shell; fixedly mounting the interface control board on the protective shell, such that the interface control board is prevented from moving, which may otherwise lead to intertwining of wires;
S3, correspondingly connecting wire harness interfaces inside an electric generator to M interfaces on a front side of the circuit board;
S4, correspondingly fixing the protective shell to a preset position of the electric generator; and
S5, correspondingly connecting wire harness interfaces outside the electric generator to the N interfaces on the back side of the circuit board.

In a preferred embodiment of the invention, the wire harness interfaces inside the electric generator comprise an inverter power output interface;
the wire harness interfaces outside the electric generator comprise wire harnesses on the control board.

Although the embodiments of the invention have been illustrated and described, those ordinarily skilled in the art can understand that various transformations, amendments, replacements and modifications may be made to these embodiments without departing from the principle and concept of the invention. The scope of the invention is defined by the claims and their equivalents.

What is claimed is:

1. An interface control board for an electric generator, comprising a circuit board, wherein M interfaces are arranged on a front side of the circuit board, N interfaces are arranged on a back side of the circuit board, M and N are positive integers, and M>N;
the interface control board for an electric generator further comprises interface circuits arranged on the circuit board, and the M interfaces are converted into the N interfaces by means of the interface circuits.

2. The interface control board for an electric generator according to claim 1, wherein the M interfaces comprise one or any combination of an AC line interface J20, an AC line interface J23, an AC ground wire interface J16, a master damper interface J11, a charging interface J7, a master reset and idle interface J8, a voltage stabilizer 0802 and USB interface J3, a thermal protection and cigarette lighter interface J2, a CO display panel interface J15, a display instrument interface J26, a power switch interface J4, a slave damper interface J12, a slave reset and idle interface J10, a master/slave operation selection interface J19, a control module 8-core interface J24, a one-touch start interface J25, a control module 12-core interface J17, an ATS interface J1, a control module 4-core interface J18 and an LED three-in-one display panel interface J28.

3. The interface control board for an electric generator according to claim 1, wherein the N interfaces comprise one or any combination of a DC interface J5, a DC interface J6, an AC interface J21, an AC interface J22, an AC ground wire interface J13, an AC ground wire interface J14, a CO interface J9, a master 16-core interface J27, a master 12-core interface J30, a slave 16-core interface J29 and a slave 12-core interface J31.

4. The interface control board for an electric generator according to claim 1, wherein the interface circuits comprise one or any combination of a first power interface circuit, a second power interface circuit, a thermal protection and cigarette lighter interface circuit, an ATS interface circuit, a power switch interface circuit, a charging interface circuit, a master reset and idle interface circuit, a slave reset and idle interface circuit, an AC ground wire interface circuit, a master 16-core interface circuit, a master 12-core interface circuit, a slave 16-core interface circuit, a slave 12-core interface circuit, a display instrument interface circuit, a CO interface circuit, a control module 8-core interface circuit, a control module 12-core interface circuit, a master 12-core interface circuit, a control module 4-core interface module and an AC interface circuit.

5. The interface control board for an electric generator according to claim 1, wherein a first power interface circuit is configured as follows: a first pin of a DC interface J5 is connected to a first terminal of a fuse F2, a second terminal of the fuse F2 is connected to a positive pole of a diode D3, and a negative pole of the diode D3 outputs a power supply KEY_DC_12V; a second pin of the DC interface J5 is connected to a power ground; a third pin of the DC interface J5 outputs a power supply BAT;
the first power interface circuit is further configured as follows: the first pin of the DC interface J5 is connected to a first terminal of a fuse F3, a second terminal of the fuse F3 is connected to a positive pole of a diode D4, and a negative pole of the diode D4 outputs a power supply CO_12V;
the first power interface circuit is further configured as follows: the second terminal of the fuse F2 is connected to the second terminal of the fuse F3, such that the power supply KEY_DC_12V and the power supply CO_12V will still be output even if the fuse F2 and the fuse F3 are not fused at the same time;
a second power interface circuit is configured as follows: a first pin of a DC interface J6 is connected to a first terminal of a fuse F4, a second terminal of the fuse F4 is connected to a positive pole of a diode D6, and a negative pole of the diode D6 outputs the power supply KEY_DC_12V; a second pin of the DC interface J6 is connected to the power ground; a third pin of the DC interface J6 outputs the power supply BAT;
the second power interface circuit is further configured as follows: the positive pole of the diode D6 is connected to the negative pole of the diode D3, such that the power KEY_DC_12V is output by the first pin of the DC interface J5 or/and the first pin of the DC interface J6;
the second power interface circuit is further configured as follows: the first pin of the DC interface J6 is connected to a first terminal of a fuse F5, a second terminal of the fuse F5 is connected to a positive pole of a diode D5, and a negative pole of the diode D5 outputs the power supply CO_12V;
the second power interface circuit is further configured as follows: the negative pole of the diode D5 is connected to the negative pole of the diode D4, such that the power supply CO_12V is output by the first pin of the DC interface J5 or/and the first pin of the DC interface J6;
the second power interface is further configured as follows: the second terminal of the fuse F4 is connected to the second terminal of the fuse F5, such that the power supply KEY_DC_12V and the power supply CO_12V will still be output even if the fuse F4 and the fuse F5 are not fused at the same time;
a thermal protection and cigarette lighter interface circuit is configured as follows: a first pin of a thermal protection and cigarette lighter interface J2 is connected to the power supply CO_12V, a second pin of the thermal protection and cigarette lighter interface J2 and a third pin of the thermal protection and cigarette lighter interface J2 are connected to a first pin of a voltage stabilizer 0802 and USB interface J3, and a fourth pin of the thermal protection and cigarette lighter interface J2 is connected to the power ground;
a voltage stabilizer 0802 and USB interface circuit is configured as follows: the first pin of the voltage stabilizer 0802 and USB interface J3 is connected to the second pin of the thermal protection and cigarette lighter interface J2 and the third pin of the thermal protection and cigarette lighter interface J2, a second pin of the voltage stabilizer 0802 and USB interface J3 is connected to the power ground, a third pin of the voltage stabilizer 0802 and USB interface J3 is connected to a fourth pin of the voltage stabilizer 0802 and USB interface J3, and a fifth pin of the voltage stabilizer 0802 and USB interface J3 is connected to the power ground;
an ATS interface circuit is configured as follows: a first pin of an ATS interface J1 is connected to a ninth pin of a control module 12-core interface J17, a second pin of the ATS interface J1 is connected to the power ground, and a third pin of the ATS interface J1 is connected to the power supply KEY_DC_12V;
an AC interface circuit is configured as follows: a first pin of an AC line interface J20 and a second pin of the AC line interface J20 are respectively connected to a first pin of an AC interface J21 and a second pin of the AC interface J21; a third pin of the AC line interface J20 and a fourth pin of the AC line interface J20 are respectively connected to a third pin of the AC interface J21 and a fourth pin of the AC interface J21; a fifth pin of the AC line interface J20 and a sixth pin of the AC line interface J20 are respectively connected to a fifth pin of the AC interface J21 and a sixth pin of the AC interface J21;
a first pin of an AC interface J22 and a second pin of the AC interface J22 are respectively connected to a first pin of an AC line interface J23 and a second pin of the AC line interface J23, a third pin of the AC interface J22 and a fourth pin of the AC interface J22 are respectively connected to a third pin of the AC line interface J23 and a fourth pin of the AC line interface J23, and a fifth pin of the AC interface J22 and a sixth pin of the AC interface J22 are respectively connected to a fifth pin of the AC line interface J23 and a sixth pin of the AC line interface J23;
a power switch interface circuit is configured as follows: a first pin of a power switch interface J4 is connected to a first terminal of a fuse F1, and a second terminal of the fuse F1 is connected to the power supply BAT; a second pin of the power switch interface J4 is connected to the power supply KEY_DC_12V, a third pin of the power switch interface J4 is connected to the power ground, a fourth pin of the power switch interface J4 is connected to a negative pole of a diode D13, and a positive pole of the diode D13 is connected to a second pin of the master 16-core interface J27;
a charging interface circuit is configured as follows: a first pin of a charging interface J7 is connected to a positive pole of a diode D7, a negative pole of the diode D7 is connected to a first terminal of a fuse F6, and a second terminal of the fuse F6 is connected to the first terminal of the fuse F1; a second pin of the charging interface J7 is connected to the power ground;
the charging interface circuit is further configured as follows: the first terminal of the fuse F6 is connected to the first terminal of the fuse F1;
a master reset and idle interface circuit is configured as follows: a first pin of a master reset and idle interface J8 and a third pin of the master reset and idle interface J8 are respectively connected to a seventh pin of the master 16-core interface J27 and a ninth pin of a display instrument interface J26, a second pin of the master reset and idle interface J8 is connected to a thirteenth pin of the master 16-core interface J27, and a fourth pin of the master reset and idle interface J8 is connected to a fifteenth pin of the master 16-core interface J27;
a slave reset and idle interface circuit is configured as follows: a first pin of a slave reset and idle interface J10 and a third pin of the slave reset and idle interface J10 are respectively connected to a seventh pin of a slave 16-core interface J29 and a third pin of an LED three-in-one display panel interface J28, a second pin of the slave reset and idle interface J10 is connected to a thirteenth pin of the slave 16-core interface J29, and a fourth pin of the slave reset and idle interface J10 is connected to a fifteenth pin of the slave 16-core interface J29;
an AC ground wire interface circuit is configured as follows: a first pin of an AC ground wire interface J13 and a second pin of the AC ground wire interface J13 are respectively connected to the power ground and a second pin and a fourth pin of an AC ground wire interface J16;
the AC ground wire interface circuit is further configured as follows: a first pin of an AC ground wire interface J14 and a second pin of the AC ground wire interface J14 are respectively connected to the power ground and a first pin and a third pin of the AC ground wire interface J16;
a master 16-core interface circuit is configured as follows: a first pin of the master 16-core interface J27 is connected to an eighth pin of the display instrument interface J26; a third pin of the master 16-core interface J27 is connected to a positive pole of a diode D10, and a negative pole of the diode D10 is connected to a seventh pin of a CO interface J9; a fourth pin of the master 16-core interface J27 is connected to a sixth pin of the master 16-core interface J27; an eighth pin of the master 16-core interface J27 is connected to a fourth pin of a slave damper interface J12; a tenth pin of the master 16-core interface J27 is connected to a first pin of the slave damper interface J12; a twelfth pin of the master 16-core interface J27 is connected to a sixth pin of the slave damper interface J12; a fourteenth pin of the master 16-core interface J27 is connected to a second pin of the slave damper interface J12; a sixteenth pin of the master 16-core interface J27 is connected to a third pin of the slave damper interface J12; a ninth pin of the master 16-core interface J27 is connected to a twelfth pin of the display instrument interface J26; an eleventh pin of the master 16-core interface J27 is connected to a tenth pin of the display instrument interface J26;
a master 12-core interface circuit is configured as follows: a first pin of a master 12-core interface J30 is connected to a fifth pin of the slave damper interface J12; a second pin of the master 12-core interface J30 is connected to the power ground; a third pin of the master 12-core interface J30 is connected to an eighth pin of the control module 12-core interface J17; a fourth pin of the master 12-core interface J30 is connected to the power ground; a fifth pin of the master 12-core interface J30 is connected to the fifth pin of the slave damper interface J12; a sixth pin of the master 12-core interface J30 is connected to the power ground; an eighth pin of the master 12-core interface J30 is connected to a third pin of the control module 12-core interface J17; a seventh pin of the master 12-core interface J30 is connected to the power supply KEY_DC_12V; a ninth pin of the master 12-core interface J30 is connected to the power supply KEY_DC_12V; an eleventh pin of the master 12-core interface J30 is connected to the power supply KEY_DC_12V;
a slave 16-core interface circuit is configured as follows: a first pin of the slave 16-core interface J29 is connected to a fifth pin of the LED three-in-one display panel interface J28; a second pin of the slave 16-core interface J29 is connected to a positive pole of a diode D14, and a negative pole of the diode D14 is connected to a fourth pin of the power switch interface J4; a third pin of the slave 16-core interface J29 is connected to a positive pole of a diode D11, and a negative pole of the diode D11 is connected to the seventh pin of the CO interface J9; a fourth pin of the slave 16-core interface J29 is connected to a sixth pin of the slave 16-core interface J29; an eighth pin of the slave 16-core interface J29 is connected to a fourth pin of a master damper interface J11; a tenth pin of the slave 16-core interface J29 is connected to a first pin of the master damper interface J11; a twelfth pin of the slave 16-core interface J29 is connected to a sixth pin of the master damper interface J11; a fourteenth pin of the slave 16-core interface J29 is connected to a second pin of the master damper interface J11; a sixteenth pin of the slave 16-core interface J29 is connected to a third pin of the master damper interface J11; a ninth pin of the slave 16-core interface J29 is connected to a second pin of the LED three-in-one display panel interface J28; an eleventh pin of the slave 16-core interface J29 is connected to a first pin of the LED three-in-one display panel interface J28; a fourth pin of the LED three-in-one display panel interface J28 is connected to the power ground;
a slave 12-core interface circuit is configured as follows: a second pin of a slave 12-core interface J31, a fourth pin of the slave 12-core interface J31 and a sixth pin of the slave 12-core interface J31 are connected to the power ground; an eighth pin of the slave 12-core interface J31 is connected to a fifth pin of the master damper interface J11; a first pin of the slave 12-core interface J31 is connected to a third pin of a control module 8-core interface J24; a third pin of the slave 12-core interface J31 is connected to a fifth pin of the control module 12-core interface J17; a seventh pin of the slave 12-core interface J31, a ninth pin of the slave 12-core interface J31 and an eleventh pin of the slave 12-core interface J31 are connected to the power supply KEY_DC_12V;
a display instrument interface circuit is configured as follows: a first pin of the display instrument interface J26 is connected to an eleventh pin of the display instrument interface J26; a second pin of the display instrument interface J26 and a fourth pin of the display instrument interface J26 are connected to the power ground; a third pin of the display instrument interface J26 and a fifth pin of the display instrument interface J26 are connected to the power supply OUT_12V; a seventh pin of the display instrument interface J26 is connected to the power ground; the tenth pin of the display instrument interface J26 is connected to the eleventh pin of the master 16-core interface J27; the twelfth pin of the display instrument interface J26 is connected to the ninth pin of the master 16-core interface J27;
a CO interface circuit is configured as follows: a first pin of the CO interface J9 is connected to the power supply CO_12V; a second pin of the CO interface J9 and a fourth pin of the CO interface J9 are connected to the power ground; a third pin of the CO interface J9 is connected to a first pin of a CO display panel interface J15; a fifth pin of the CO interface J9 is connected to a third pin of the CO display panel interface J15; a sixth pin of the CO interface J9 is connected to a second pin of the CO display panel interface J15; an eighth pin of the CO interface J9 is connected to a first pin of the control module 8-core interface J24;
a control module 8-core interface circuit is configured as follows: a fifth pin of the control module 8-core interface J24 is connected to a first pin of a one-touch start interface J25, a second pin of the one-touch start interface J25 is connected to the power ground, a third pin of the one-touch start interface J25 is connected to a tenth pin of the control module 12-core interface J17, a fourth pin of the one-touch start interface J25 is connected to a twelfth pin of the control module 12-core interface J17, a fifth pin of the one-touch start interface J25 is connected to an eleventh pin of the control module 12-core interface J17, a seventh pin of the control module 8-core interface J24 is connected to the power supply KEY_DC_12V, a second pin of the control module 8-core interface J24 is connected to a third pin of a master/slave operation selection interface J19, a fourth pin of the control module 8-core interface J24 is connected to a first pin of the master/slave operation selection interface J19, a second pin of the master/slave operation selection interface J19 is connected to the power ground, a sixth pin of the control module 8-core interface J24 is connected to a positive pole of a diode D12, and a negative pole of the diode D12 is connected to the negative pole of the diode D13; an eighth pin of the control module 8-core interface J24 outputs the power supply OUT_12V;
a control module 12-core interface circuit is configured as follows: a seventh pin of the control module 12-core interface J17 is connected to the power ground, a sixth pin of the control module 12-core interface J17 is connected to the power supply KEY_DC_12V, a fourth pin of the control module 12-core interface J17 is connected to the fourth pin of the slave 16-core interface J29, a first pin of the control module 12-core interface J17 is connected to the fourth pin of the master 16-core interface J27, and a second pin of the control module 12-core interface J17 is connected to an antenna;
a master 12-core interface circuit is configured as follows: a first terminal of an input circuit of a relay K1 is connected to the power supply OUT_12V, and a second terminal of the input circuit of the relay K1 is connected to the power ground; a first terminal of a normally open output circuit of the relay K1 is connected to the power supply KEY_DC_12V, and a second terminal of the normally open output circuit of the relay K1 is connected to the fifth pin of the master 12-core interface J30;
the master 12-core interface circuit is further configured as follows: a first terminal of an input circuit of a relay K4 is connected to the power supply OUT_12V, a second terminal of the input circuit of the relay K4 is connected to the power ground, a first terminal of a normally open output circuit of the relay K4 is connected to the power supply KEY_DC_12V, and a second terminal of the normally open output circuit of the relay K4 is connected to the fifth pin of the slave 12-core interface J31;
a control module 4-core interface circuit is configured as follows: a first terminal of an input circuit of a relay K2 is connected to a negative pole of a diode D1 and the power supply KEY_DC_12V, and a second terminal of the input circuit of the relay K2 is connected to a positive pole of the diode D1 and a fourth pin of a control module 4-core interface J18; a first terminal of a normally open output circuit of the relay K2 is connected to the power ground, and a second terminal of the normally open output circuit of the relay K2 is connected to a tenth pin of the master 12-core interface J30;
the control module 4-core interface circuit is further configured as follows: a first terminal of an input circuit of a relay K3 is connected to a negative pole of a diode D2 and the power supply KEY_DC_12V, and a second terminal of the input circuit of the relay K3 is connected to a positive pole of the diode D2 and a second pin of the control module 4-core interface J18; a first terminal of a normally open output circuit of the relay K3 is connected to the power ground, and a second terminal of the normally open output circuit of the relay K3 is connected to a twelfth pin of the master 12-core interface J30;
the control module 4-core interface circuit is further configured as follows: a first terminal of an input circuit of a relay K5 is connected to a negative pole of a diode D8 and the power supply KEY_DC_12V, and a second terminal of the input circuit of the relay K5 is connected to the positive pole of the diode D2 and a third pin of the control module 4-core interface J18; a first terminal of a normally open output circuit of the relay K5 is connected to the power ground, and a second terminal of the normally open output circuit of the relay K5 is connected to a tenth pin of the slave 12-core interface J31;
the control module 4-core interface circuit is further configured as follows: a first terminal of an input circuit of a relay K6 is connected to a negative pole of a diode D9 and the power supply KEY_DC_12V, and a second terminal of the input circuit of the relay K6 is connected to a positive pole of the diode D9 and a first pin of the control module 4-core interface J18; a first terminal of a normally open output circuit of the relay K6 is connected to the power ground, and a second terminal of the normally open output circuit of the relay K6 is connected to a twelfth pin of the slave 12-core interface J31.

6. The interface control board for an electric generator according to claim 1, wherein the M interfaces comprise an AC line interface J20, an AC line interface J23, an AC ground wire interface J16, a master damper interface J11, a charging interface J7, a master reset and idle interface J8, a voltage stabilizer 0802 and USB interface J3, a thermal protection and cigarette lighter interface J2, a CO display panel interface J15, a display instrument interface J26, a power switch interface J4, a slave damper interface J12, a slave reset and idle interface J10, a master/slave operation selection interface J19, a control module 8-core interface J24, a one-touch start interface J25, a control module 12-core interface J17, an ATS interface J1, a control module 4-core interface J18 and the LED three-in-one display panel interface J28; in this case, M is 20;
the N interfaces comprise a DC interface J5, a DC interface J6, an AC interface J21, an AC interface J22, an AC ground wire interface J13, an AC ground wire interface J14, a CO interface J9, a master 16-core interface J27, a master 12-core interface J30, a slave 16-core interface J29 and a slave 12-core interface J31; in this case, N is 11.

7. The interface control board for an electric generator according to claim 1, wherein the interface circuits comprise a first power interface circuit, a second power interface circuit, a thermal protection and cigarette lighter interface circuit, an ATS interface circuit, a power switch interface circuit, a charging interface circuit, a master reset and idle interface circuit, a slave reset and idle interface circuit, an AC ground wire interface circuit, a master 16-core interface circuit, a master 12-core interface circuit, a slave 16-core interface circuit, a slave 12-core interface circuit, a display instrument interface circuit, a CO interface circuit, a control module 8-core interface circuit, a control module 12-core interface circuit, a master 12-core interface circuit, a control module 4-core interface module and an AC interface circuit.

8. The interface control board for an electric generator according to claim 1, wherein the circuit board is an independent circuit board or formed by multiple independent circuit boards.

9. An operating method of an interface control board for an electric generator, comprising the following steps:
S1, preparing a protective shell, a length and width of which are greater than or equal to a length and width of a circuit board;
S2, forming N through-holes, matching N interfaces in size and position, in the protective shell to allow the N interfaces on a back side of the circuit board to stretch out of the protective shell;
S3, correspondingly connecting wire harness interfaces inside an electric generator to M interfaces on a front side of the circuit board;
S4, correspondingly fixing the protective shell to a preset position of the electric generator; and
S5, correspondingly connecting wire harness interfaces outside the electric generator to the N interfaces on the back side of the circuit board.

10. The operating method of an interface control board for an electric generator according to claim 9, wherein the wire harness interfaces inside the electric generator comprise an inverter power output interface, and the wire harness interfaces outside the electric generator comprise wire harnesses on a control board.
